(19) United States
(12) Patent Application Publication
(10) Pub. No.: US 2018/0205072 A1
(43) Pub. Date: Jul. 19, 2018

(54) LEAD ACID STORAGE BATTERY

(71) Applicant: GS Yuasa International Ltd., Kyoto-shi, Kyoto (JP)

(72) Inventors: Kazuhiro SUGIE, Shizuoka (JP); Yoshinobu SATO, Shizuoka (JP); Takeshi CHIBA, Shizuoka (JP); Yu KOJIMA, Shizuoka (JP); Etsuko OGASAWARA, Shizuoka (JP); Kenji IZUMI, Shizuoka (JP)

(21) Appl. No.: 15/744,534

(22) PCT Filed: May 24, 2016
(86) PCT No.: PCT/JP2016/002501

§ 371 Date: Jan. 12, 2018

(30) Foreign Application Priority Data
Jul. 21, 2015 (JP) 2015-143904

(51) Int. Cl. H01M 4/14; H01M 10/06; H01M 4/73

(52) U.S. Cl. CPC H01M 4/14; H01M 4/73; H01M 10/06

(57) ABSTRACT

A lead acid storage battery including: positive electrode plates each including a positive electrode grid and a positive electrode active material, and negative electrode plates each including a negative electrode grid and a negative electrode active material. The positive and negative electrode plates are stacked alternately with a separator therebetween to form an electrode plate group. The battery further includes: a battery container having cell chambers each containing the electrode plate group and electrolyte, and a cover sealing an opening of the battery container. The positive electrode active material has a pore distribution having a peak in region A from 0.03 μm to 0.1 μm and a peak in region B from 0.2 μm to 1.0 μm, and a ratio AM/BM of peak AM in region A to peak BM in region B is 0.34 or more and 0.70 or less. The negative electrode grid contains bismuth in an amount of 1 ppm or more and 300 ppm or less.

### TECHNICAL FIELD

The present invention relates to a lead acid storage battery for car starter.

### BACKGROUND ART

Among lead acid storage batteries for car starter, those to be mounted in cars equipped with idling stop system are supposed to be deeply discharged to a relatively low SOC (State Of Charge) region, and therefore, required to have durability against repeated deep discharge.

Patent Literatures 1 and 2 disclose techniques of optimizing the pore structure of positive electrode active material, on the basis of the results of cycle life test including relatively deep discharge and other factors. These techniques appear to be potentially applicable to the aforementioned lead acid storage batteries used in cars equipped with idling stop system.

### CITATION LIST

### Patent Literature

[PTL 1] Japanese Laid-Open Patent Publication No. Hei 10-69900
[PTL 2] Japanese Laid-Open Patent Publication No. Hei 11-73950

### SUMMARY OF INVENTION

### Technical Problem

With cars equipped with idling stop system getting more widely used in recent years, there occur some cases where the lead acid storage battery is operated not only under the deep discharge condition but also under other various severe conditions for the lead acid storage battery. Under such circumstances, even by employing the techniques of Patent Literatures 1 and 2, in practical use in the car where the battery is subjected to repeated charge and discharge, the battery often fails to exert its cycle life characteristics sufficiently.

The present disclosure is made in view of the above problem, and aims to provide a highly reliable lead acid storage battery that can exert its cycle life characteristics sufficiently even when operated under comparatively severe idling stop conditions.

### Solution to Problem

A lead acid storage battery according to the present disclosure includes: positive electrode plates each including a positive electrode grid and a positive electrode active material, and negative electrode plates each including a negative electrode grid and a negative electrode active material. The positive electrode plates and the negative electrode plates are stacked alternately with a separator between the positive electrode plate and the negative electrode plate to form an electrode plate group. The lead acid storage battery further includes: a battery container having a plurality of cell chambers each containing the electrode plate group and an electrolyte, and a cover sealing an opening of the battery container. The positive electrode active material has a pore diameter distribution having a peak in a region A from 0.03 μm to 0.1 μm and a peak in a region B from 0.2 μm to 1.0 μm, and a ratio AM/BM of a peak AM in the region A to a peak BM in the region B is 0.34 or more and 0.70 or less. The negative electrode grid contains bismuth in an amount of 1 ppm or more and 300 ppm or less.

In a preferable embodiment, at least the positive electrode plate is provided with on a surface thereof with a retainer mat made of non-woven fabric comprising glass, polyester, or the like.

### Advantageous Effects of Invention

According to the present disclosure, it is possible to provide a highly reliable lead acid storage battery that can exert its cycle life characteristics sufficiently even when operated under comparatively severe idling stop conditions.

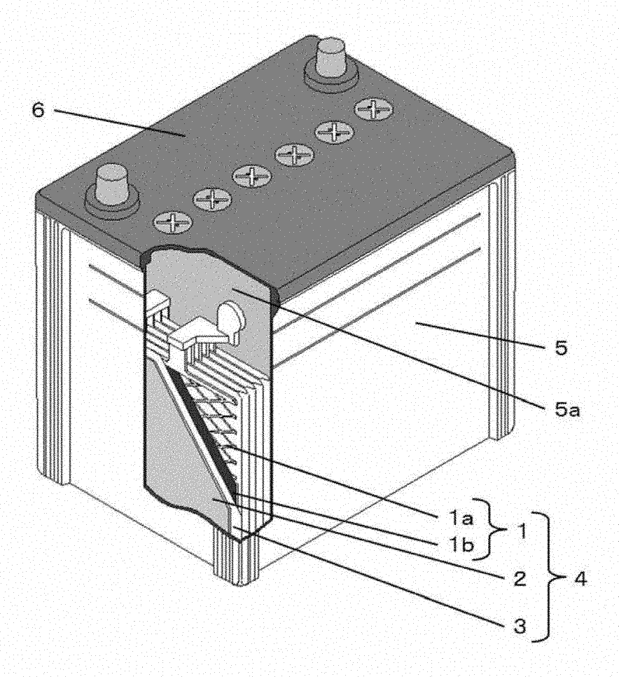

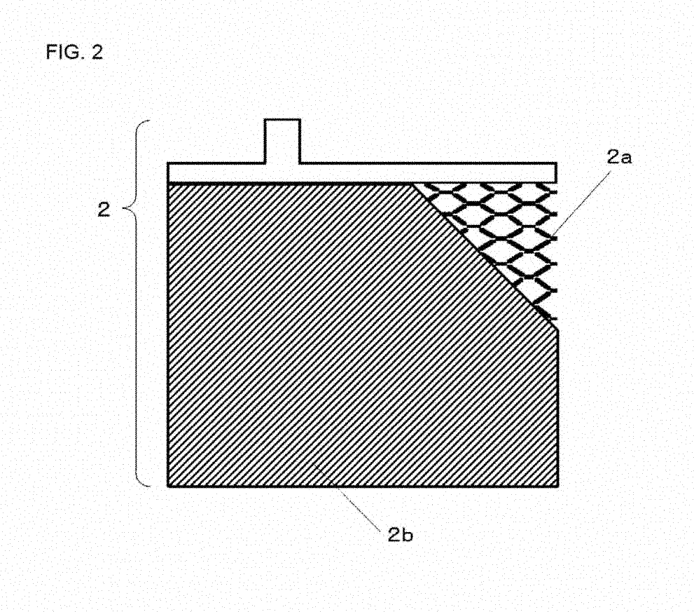

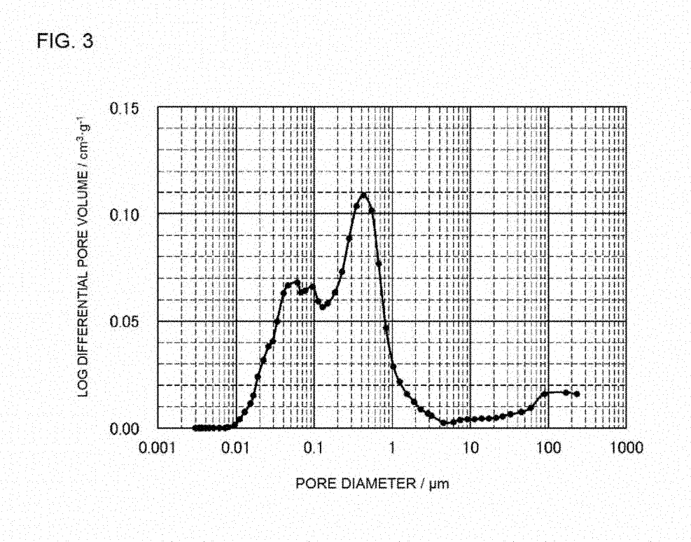

### BRIEF DESCRIPTION OF DRAWINGS

[FIG. 1] A schematic overview of a lead acid storage battery according to one embodiment of the present invention.

[FIG. 2] An exemplary view of an essential part of the lead acid storage battery according to one embodiment of the present invention.

[FIG. 3] An exemplary pore distribution of a positive electrode active material according to one embodiment of the present invention.

### DESCRIPTION OF EMBODIMENTS

Embodiments of the present invention will be described below in detail with reference to drawings. FIG. 1 is a schematic overview of a lead acid storage battery according to one embodiment of the present invention. FIG. 2 is an exemplary view of a negative electrode plate, an essential part of the lead acid storage battery according to one embodiment of the present invention.

A plurality of electrode plate groups 4 each including positive electrode plates 1 and negative electrode plates 2 stacked alternately one on another with a separator 3 therebetween are placed in a battery container 5 having a plurality of cell chambers 5a, together with an electrolyte (not shown). The opening of the battery container 5 is sealed with a cover 6. Here, the positive electrode plate 1 includes a positive electrode grid 1a and a positive electrode active material 1b, and the negative electrode plate 2 includes a negative electrode grid 2a and a negative electrode active material 2b.

One embodiment of the present invention includes two features. The first is that the positive electrode active material 1b has a pore distribution having a peak in a region A from 0.03 μm to 0.1 μm and a peak in a region B from 0.2 μm to 1.0 μm, and a ratio AM/BM of a peak AM in the region A to a peak BM in the region B is 0.34 or more and 0.70 or less.

FIG. 3 is an example of the pore distribution of the positive electrode active material, corresponding to the first feature of one embodiment of the present invention. The second is that the negative electrode grid 2a contains bismuth in an amount of 1 ppm or more and 300 ppm or less.

Among the problems associated with idling stop control, deep discharge is considered as the most serious one at the early phase of development, because during an idle stop, power is supplied to the load (temperature controller light, etc. from the lead acid storage battery only.

If such deep discharge is the only problem that matters in idling stop control, employing the techniques disclosed in Patent Literatures 1 and 2 might possibly be enough to solve the problem. In recent years, however, a considerable number of the cars equipped with idling stop system have been increasingly employing a control method of generating a regenerative current at the time of braking and the like and charging the lead acid storage battery with the regenerative current. In order to achieve more efficient charging with the regenerated current, it is desirable to keep the SOC of the lead acid storage battery relatively low (so as not to be fully charged). In addition, the lead acid storage batteries for idling stop control are expected to be much more often subjected to a discharge by which a large current equivalent to several tens of C is instantaneously drawn from the battery, as compared to the conventional lead acid storage batteries for car starter. Under such circumstances, the configurational conditions of the lead acid storage battery as disclosed in Patent Literature 1 or 2, which are optimized by focusing on the cycle life based on the changes in discharge capacity at a constant current, are insufficient for the battery to exert its satisfactory performance.

Specifically, as charge and discharge in which the battery is frequently discharged with large current are repeated under the condition where the SOC is below 100%, a phenomenon called acid stratification occurs, i.e., the sulfate ion concentration in the electrolyte becomes smaller in the upper layer portion than in the lower layer portion. When this occurs, in the upper layer portion where the sulfate ion concentration is relatively depleted, lead sulfate as a discharge product is unlikely to be produced (discharge is difficult to proceed).

On the other hand, in the lower layer portion where the sulfate ion concentration is relatively in excess, sulfate ions are unlikely to be dissociated from the lead sulfate (charge is difficult to proceed). Due to this imbalance, the lead sulfate present in excess in the lower layer portion deposits, slowing down the discharge reaction as a whole. This results in deterioration in cycle life characteristics. The stratification is eliminated when the electrolyte is agitated by the gas generated through hydrolysis of electrolyte (gas generation) that occurs in the terminal stage of charging. Under the condition where the SOC is intentionally controlled to below 100%, however, charging cannot proceed to the terminal stage, and the above effect cannot be expected.

To solve this problem, one embodiment of the present invention employs the above-described two features. The first feature is that the positive electrode active material 1b is made to have a pore distribution having a peak in the region A from 0.03 μm to 0.1 μm and a peak in the region B from 0.2 μm to 1.0 μm, such that the peak AM in the region A and the peak BM in the region B are in the ratio AM/BM of 0.34 or more and 0.70 or less.

In Patent Literature 1, as disclosed in Examples, metal lead and lead monoxide are classified, thereby to shift the peak from the region B to a region from 1.0 μm to 5.0 μm. The ordinary positive electrode active material 1b, which is not classified, has the peak BM in the region B. By adding red lead to a precursor paste thereof, the positive electrode active material 1b can have another peak AM in the region A.

Although the detailed reasons are not yet clear, the peak AM acts to increase the capacity of the positive electrode plate 1. It is to be noted, however, that when the ratio AM/BM is as small as that of Comparative Example 1 without red lead of Patent Literature 1 (ratio AM/BM=0.31), the capacity cannot be increased. The present inventors have found as a result of intensive studies that when the AM/BM become lower than 0.34, the capacity drops drastically.

On the other hand, when the battery is repeatedly charged while the SOC is controlled to be relatively low (so as not to be fully charged), lead sulfate builds up, and this causes the cycle life characteristics to degrade even more, due to the high capacity of the positive electrode plate 1.

The present inventors have found as a result of intensive studies that when the ratio AM/BM exceeds 0.70, the deterioration in cycle life characteristics caused by the aforementioned reasons becomes severe.

Therefore, the ratio AM/BM should be 0.34 or more and 0.70 or less. Specifically, decreasing the amount of red lead to be added to the paste can lower the AM, and, conversely, increasing the amount of red lead can raise the AM. The ratio AM/BM can be thus optimized by adjusting the amount of red lead to be added in the paste preparation process.

The second feature is that bismuth is contained in the negative electrode grid 2b in an amount of 1 ppm or more and 300 ppm or less. The presence of an appropriate amount of bismuth in the negative electrode grid 2a decreases the hydrogen overvoltage, and hydrogen gas is likely to be generated even though the SOC is below 100%, allowing the diffusion of the electrolyte to easily occur. This, as a result, can eliminate the stratification.

In order to obtain this effect, it is desirable to contain bismuth in the negative electrode gird 2a in an amount of 1 ppm or more. When the amount exceeds 300 ppm, however, the hydrogen overvoltage will decrease too much, and the hydrolysis of electrolyte occurs excessively, reducing the electrolyte significantly. This accelerates the corrosion of current collecting portions (tabs) exposed out of the electrolyte of the positive and negative electrode plates 1 and 2, resulting conversely in deterioration in the cycle life characteristics.

According to one embodiment of the present invention configured to include the above-described two features, it is possible to provide a lead acid storage battery that can exert its life characteristics sufficiently while maintaining its high capacity, even when charged and discharged repeatedly under the condition where the SOC is below 100%.

The effect of one embodiment of the present invention is further increased by providing a retainer mat on a surface of the positive electrode plate 1. Since the ratio AM/BM is adjusted to be a relatively large value, the positive electrode active material 1b tends to soften and separate from the positive electrode plate 1, which results in a decrease in capacity (or degradation in cycle life characteristics). By providing the retainer mat, the positive electrode active material 1b can be physically retained and prevented from separating from the positive electrode plate.

The advantageous effects of one embodiment of the present invention will now be described below with reference to Examples.

(1) Fabrication of Lead Acid Storage Battery

A D26L-size lead acid storage battery specified in JISD5301 was fabricated in the present Example. The cell chambers 5a each accommodate eight positive electrode plates 1 and nine negative electrode plates 2. The positive electrode plates 1 are each provided on its surface with a retainer mat, except those of Battery C-1, such that the retainer mat and the positive electrode plate 1 are abutted to each other.

The positive electrode plate 1 was obtained by kneading a lead oxide powder with sulfuric acid and purified water, to prepare a precursor paste of a positive electrode active material 1b, and filling the paste into a positive electrode grid 1a (expanded grid) made of a lead alloy sheet (thickness: 1.1 mm) containing calcium.

The negative electrode plate 2 was obtained by kneading a lead oxide powder in which carbon and an organic additive were added in advance, with sulfuric acid and purified water, to prepare a precursor paste of a negative electrode active material 2b, and filling the paste into a negative electrode grid 2a (expanded grid) made of a lead alloy sheet (thickness: 1.1 mm) containing calcium and, depending on the condition, bismuth.

Here, the mass ratio of the bismuth contained in the negative electrode grid 2a was varied as shown in Table 1.

The obtained positive and negative electrode plates 1 and 2 were aged and dried. Afterwards, the negative electrode plates 2 were each placed inside a bag-shaped separator 3 made of polyethylene, and stacked on the positive electrode plates 2 alternately one on another, to obtain an electrode plate group 4 comprising eight positive electrode plates 1 and nine negative electrode plates 2 with the separator 3 interposed between the positive and negative electrodes. The electrode plate group 4 was placed into each of six cell chambers 5a divided by a partition, and six cells were directly connected to each other. Subsequently, an electrolyte comprising a dilute sulfuric acid was injected to perform chemical formation. A lead acid storage battery was thus produced.

(2) Cycle Life Characteristics

The fabricated lead acid storage batteries, after the SOC was adjusted to 90%, were evaluated by following the steps below.
A. Subjecting battery to discharge at 45 A for 59 seconds
B. Subjecting battery to discharge at 300 A for 1 second
C. Subjecting battery to 14.0 V constant-voltage charge for 60 seconds with maximum current limited to 100 A
D. After 3600-times repetition of a charge-discharge cycle consisting of A, B and C performed in this order, subjecting battery to refresh charge, i.e., 14.0 V constant-voltage charge for 20 minutes

The above A to D were repeated, and at the point when the voltage at the discharge at 300 A for 1 second dropped to 7.2 V or less, the battery was judged as having reached the end of the life, and the evaluation was discontinued. The number of cycles performed until the evaluation was discontinued was measured, and converted into a percentage (%), with the number of cycles of Battery C-1 taken as 100. The percentage thus determined is shown in Table 1 as the cycle life characteristics of each battery, together with the constitutional conditions.

(3) Battery Capacity

The batteries in a fully charged state were discharged at a 5-hour rate current until the terminal voltage reached 10.5 V. The discharged electricity quantity at this point was measured, and converted into a percentage (%), with the discharged electricity quantity of Battery C-1 taken as 100. The percentage thus determined is shown in Table 1 as the discharge capacity of each battery, together with the constitutional conditions.

TABLE 1

| | | Bismuth in | Retainer | | |
|---|---|---|---|---|---|
| | | negative | mat on | | |
| | | electrode | positive | | |
| | Ratio | grid | electrode | Battery | Cycle life |
| Battery | AM/BM | (ppm) | plate | capacity | characterisctics |
| A-1 | 0.32 | 150 | With | 88% | 108% |
| A-2 | 0.34 | 150 | With | 95% | 109% |
| A-3 | 0.42 | 150 | With | 99% | 111% |
| A-4 | 0.50 | 150 | With | 100% | 110% |
| A-5 | 0.60 | 150 | With | 105% | 105% |
| A-6 | 0.70 | 150 | With | 109% | 99% |
| A-7 | 0.73 | 150 | With | 110% | 87% |
| B-1 | 0.50 | 0.5 | With | 100% | 80% |
| B-2 | 0.50 | 1 | With | 101% | 92% |
| B-3 | 0.50 | 10 | With | 100% | 103% |
| B-4 | 0.50 | 50 | With | 100% | 105% |
| B-5 | 0.50 | 200 | With | 99% | 108% |
| B-6 | 0.50 | 250 | With | 99% | 101% |
| B-7 | 0.50 | 300 | With | 99% | 95% |
| B-8 | 0.50 | 330 | With | 99% | 86% |
| C-1 | 0.50 | 150 | Without | 100% | 100% |

Comparison is made to Batteries A-1 to A-7. In Battery A-1 in which the ratio AM/BM was below 0.34, the battery capacity was extremely decreased. This is due to the reason that the peak AM in the region A acting to increase the capacity of the positive electrode plate 1 was relatively low. It is not yet clear, however, why the ratio has an inflection point at 0.34.

On the other hand, in Battery A-7 in which the ratio was above 0.70, the cycle life characteristics were degraded. Battery A-7 was disassembled, and softening of the positive electrode active material 1b was observed. This indicates that the ratio AM/BM is preferably 0.34 or more and 0.70 or less.

Comparison is made to Batteries B-1 to B-8. In Battery B-1 in which the amount of bismuth in the negative electrode grid 2a was below 1 ppm and Battery B-8 in which it was above 300 ppm, the cycle life characteristics were degraded. Each battery was disassembled, and severe stratification of electrolyte was observed in Battery B-1, and depletion of electrolyte was observed in Battery B-9. This indicates that bismuth is preferably contained in the negative electrode grid 2a in an amount of 1 ppm or more and 300 ppm or less.

The evaluation results of Batteries A-1 to A-7 taken along with those of Batteries B-1 to B-9 show that it is preferable that both the ratio AM/BM and the amount of bismuth in the negative electrode grid 2a are in the above ranges.

Comparison is made between Batteries C-1 and A-4. These two batteries were configured similarly, except that the retainer mat as provided on the surface of the positive electrode plate tin Battery A-4 was not provided in Battery C-1. Despite this slight difference, the cycle life characteristics of Battery C-1 were degraded. The retainer mat plays a role to physically hold the positive electrode active material 1, preventing its separation from the positive electrode plate. Presumably, in Battery C-1 without the retainer mat, this effect was not obtained. Battery C-1 was disassembled, and slight softening and separation of the positive electrode active material 1b was observed. It is therefore preferable to provide the retainer mat on the surface of the positive electrode plate 1.

Although the present invention is described above by way of preferable embodiments, such description should not be construed as limiting the invention, and various variations are possible. For example, the positive electrode grid 1a, like the negative electrode grid 2a, may be configured to contain bismuth in an amount of 1 ppm or more and 300 ppm or less.

### INDUSTRIAL APPLICABILITY

The present invention can be usefully applied to the lead acid storage battery used in a car equipped with idling stop system.

### REFERENCE SIGNS LIST

1: positive electrode plate

1a: positive electrode grid

1b: positive electrode active material

2: negative electrode plate

2a: negative electrode grid

2b: negative electrode active material

3: separator

4: electrode plate group

5: battery container

5a: cell chamber

6: cover

1. A lead acid storage battery, comprising:
positive electrode plates each including a positive electrode grid and a positive electrode active material, and
negative electrode plates each including a negative electrode grid ant a negative electrode active material,
the positive electrode plates and the negative electrode plates being stacked alternately with a separator between the positive electrode plate and the negative electrode plate to form an electrode plate group;
a battery container having a plurality of cell chambers each containing the electrode plate group and an electrolyte; and
a cover sealing an opening of the battery container,
the positive electrode active material having a pore diameter distribution having a peak in a region A from 0.03 μm to 0.1 μm and a peak in a region B from 0.2 μm to 1.0 μm, and a ratio AM/BM of a peak AM is the region A to a peak BM in the region B is 0.34 or more and 0.70 or less, and
the negative electrode grid containing bismuth in an amount of 1 ppm or more and 300 ppm or less.

2. The lead acid storage battery of claim 1, wherein at least the positive electrode plate is provided on a surface thereof with a retainer mat.
